(19) United States
(12) Patent Application Publication
(10) Pub. No.: US 2003/0024402 A1
(43) Pub. Date: Feb. 6, 2003

(54) Multi use device for house use in particular for children's feeding

(76) Inventor: Carlo Rosa, Lecco (IT)

Correspondence Address: LARSON & TAYLOR, PLC, 1199 NORTH FAIRFAX STREET, SUITE 900, ALEXANDRIA, VA, 22314, US

(21) Appl. No.: 10/130,212

(22) PCT Filed: Jan. 4, 2001
(86) PCT No.: PCT/EP01/00042

(30) Foreign Application Priority Data
Feb. 9, 2000 (IT) GE2000U 00004

(51) Int. Cl. A01J 11/04

(52) U.S. Cl. 99/467

(57) ABSTRACT

Multi-use device for domestic use, and particularly for the children's feeding, including steam generating (20) and supplying (23, 24, 25) means, operating means (30, 31, 32, 33), a working container (1) where it can be set alternatively: food products mincing means (6, 206), containing means (5) for the steam cooking of food products, and supporting means (203) for the steam sterilization of items such as baby's bottles or the like, being houseable within said container steam diffusion means (102, 3), said steam diffusion means including a diffusion device (3) communicating with said steam supplying means (23, 24), able to support both the containing means (5) for the food products steam cooking, and the support means (203) of the items destined to the sterilization.

### DESCRIPTION

The present invention refers to a multi-use device for domestic use, and in particular a multi-use device useful in the children's feeding.

Actually the market offer several multi-use devices useful for the preparation of foods, in particular able to mix, mince and perform operations like these. Moreover on the market are, in particular for the preparation of children's foods, devices able to steam cook and mince the foods. Said devices are provided with a suitable boiler able to supply steam into a suitable cooking container, and with a set of rotating blades provided with suitable operating means, which is normally positioned in the same container where the steam cooking is performed. Another device normally used in the child care is the sterilizer; but in this case the use of the steam has to be combined to spaces sufficient to house more food use containers, such as baby's bottles or the like. In both cases is quite important that the steam diffusion within the working container occurs uniformly and homogeneously, so to make the processes more fast and effective.

Aim of the present invention is then to get a multi-use device where it is possible to combine in a simple conception structure both the cooking and mincing functions and the sterilization function.

Object of the present invention is then a multi-use device for domestic use, and in particularly for the children's feeding, including steam generating and supplying means, operating means, a working container where it can be set alternatively: food products, raw or cooked, mincing means, containing means for the steam cooking of food products and supporting means for the steam sterilization of items such as baby's bottles or the like, being houseable within said container steam diffusion means, said steam diffusion means including a supplying device communicating with said steam supplying means, able to support both the containing means for the food products steam cooking, and the support means of the items destined to the sterilization.

Further advantages and features of the device according to the present invention will be better understood from the following detailed description of an embodiment form of the same, made as a not limitative description, and with reference to the figures of the enclosed drawings, where:

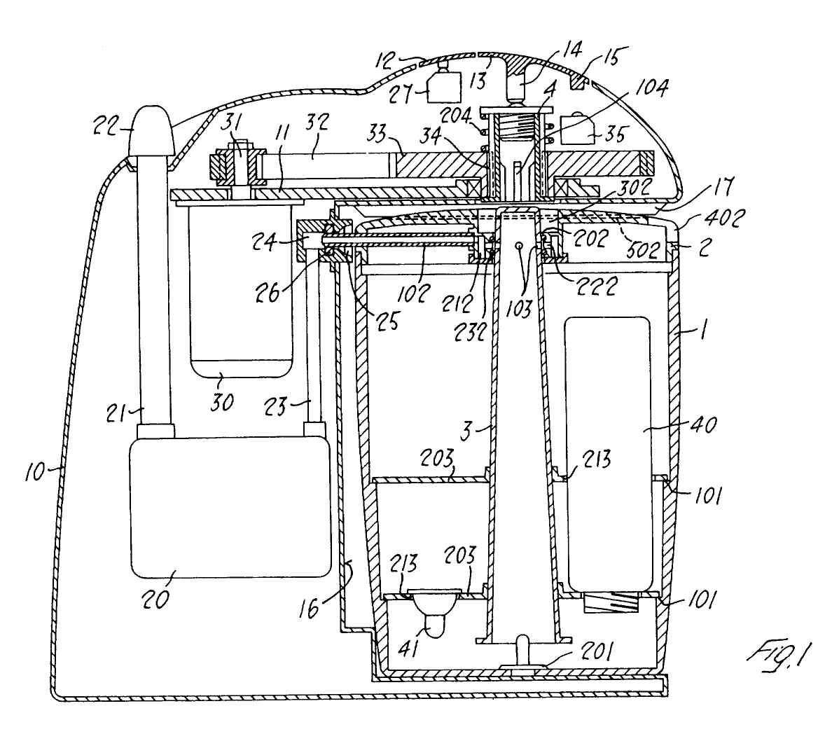

FIG. 1 is a longitudinal section view of the device according to the present invention, used as sterilizer;

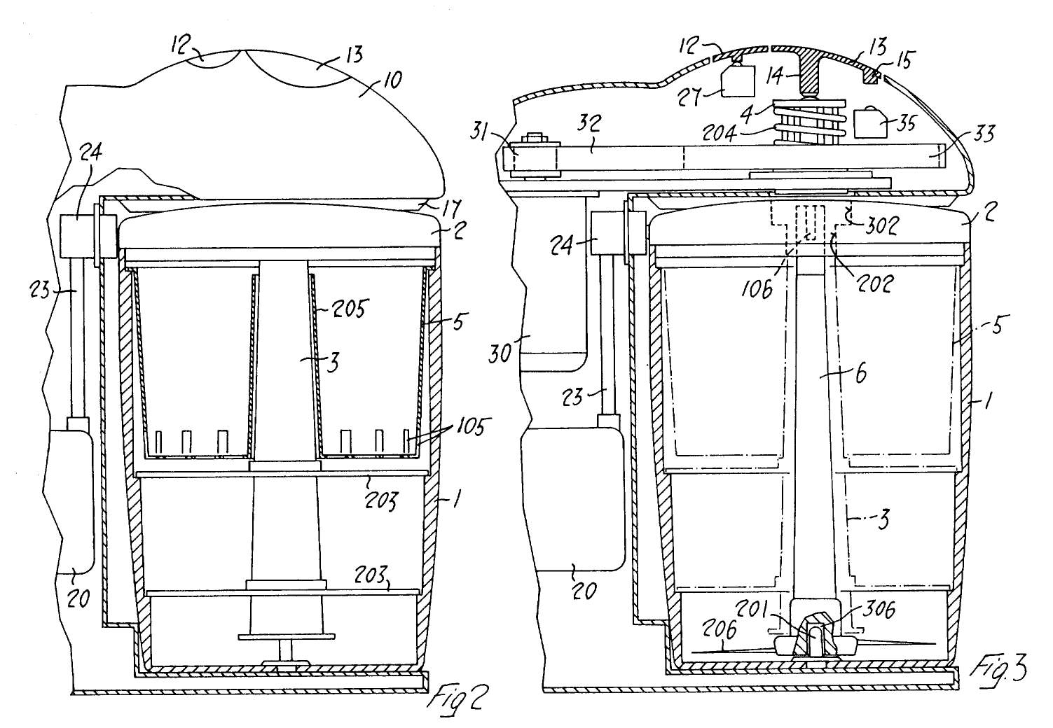

FIG. 2 is a longitudinal section view of a detail of the device of the invention, used as steam cooker;

FIG. 3 is a longitudinal section view of a detail of the device of the invention, used as mincer.

FIG. 1 shows an embodiment form of the device according to the present invention; numeral 1 designates the device working container. The device includes, in a support frame 10, a boiler 20, provided with a feeding duct 21 at whose end is set the security cap 22, and with a supplying duct 23, ending with the supplying chamber 24, opening through the hole 25 provided with sealing means 26 on the side wall of the frame 10 housing 16, where is set the container 1. In the frame is moreover housed the motor 30 which through the shaft 31 and the drive belt 32 transmits the motion to the wheel 33 having in its axial hole 34 the connector 4, which allows the starting up of the mincing device (not shown in figure).

Said connector is an hollow tubular sleeve, inside which there are radial reliefs 104, provided with the elastic return spring 204 working on the wheel 33; the connector 4 closed end is in connection with the pin 14 of the push-button 13; the other pin 15 of the same push-button operates on the microswitch 35 which starts up the motor 30. On the frame is also provided the push-button 12 which starts up the microswitch 27 of the boiler 20.

The container 1 houses the diffusion device 3 which is a frustum of cone tubular body open on its end turned to the bottom of the container; at two different vertical levels of said diffusion device are connected the support elements of the items to be sterilized, in particular they are the plates 203, provided with through holes 213, radially projecting from said diffusion device 3, overhanging on the reinforcements 101 formed on the container 1 inner wall; on the plates 203 are placed the baby's bottle 40 and the teat 41. The end of the diffusion device 3 turned to the mouthpiece of the container 1 is inserted in the hole 202 axially obtained in the cap 2 of said container. Around said hole 202 is embodied the annular chamber 212, communicating with the holes 103 obtained at the end of the diffusion device 3 thanks to the radial ducts 222. Said chamber is at its turn in connection with one end of the spout 102, the opposite end of said spout being inserted in the hole 25 of the supplying chamber 24. The top of the diffusion device 3 is housed in the cavity 302 obtained on the cap 2 upper wall. On said wall are moreover obtained the grooves 502 destined to cooperate with the guides 17 projecting downward from the wall of the housing 16 of the frame 10. The exhaust duct 402 is moreover obtained radially as to the cap 2.

In FIG. 2 the invention device is shown in food products steam cooking set up. As it can be noticed, within the container 1 is set the basket 5, whose central frustum of cone sleeve 205 is suitable to be positioned on the diffusion device 3. The bottom of the basket 5 has the holes 105, allowing the diffusion of the steam inside the basket itself, ad then the cooking of the foods it contains.

In FIG. 3 is finally shown the device when it is ready to perform the mincing function. The grinding tool is a shaft 6 axially inserted within the container 1; its end turned to the container 1 bottom has the blades 206, and is provided with a cavity 306 cooperating with the pin 201 positioned on the bottom of said container 1. At the opposite end the shaft 6 is provided with a key hub 106 destined to cooperate with the reliefs 104 of the cavity within the connector 4. The hub projects out of the axial hole 202 bored in the cap 2, and comes out in connection with the cavity 302.

The functioning of the device according to the present invention will become clear from the following. With reference to FIGS. 1 and 2, it can be noticed how the device 3 for the diffusion of the steam into the container 1 is set in order to offer the necessary support both for the insertion of the items destined to the steam sterilization, such as the baby's bottle 40 and the teat 41, and for the container where are put the foods destined to the steam cooking. The so embodied diffusion device guarantees an homogeneous distribution of the steam in the container, and at the same time allows to use the device for two different purposes which until now were performed by devices different from each other.

Advantageously, the abutment 101 formed on the container 1 inner wall allow to set the diffuser 3 in a position such that its open end turned to the container 1 bottom is able to pour out the steam supplied by the boiler 20 into the container itself. An analogous result could have been obtained providing for one or more openings on the diffuser 3 wall in connection with said ends; in that case the diffuser could have been extended as far as near the container 1 bottom. The plates 203 can be firmly connected to the diffuser, as in the shown case, or even they can be embodied removable from it. In the shown case, the plates 203 are the suspension means of the diffuser 3 in the container 1; this solution offers the advantage to prevent the forming of condensate accumulation within the diffuser itself.

The steam is supplied into the container in an absolutely safe way, thanks to the insertion of the pour 102 in the supplying chamber 24; this type of connection prevents moreover the dripping along the walls of the housing 16. The pour 102 is inserted into the hole 25 of the supplying chamber 24 in a very simple way, thanks to the presence of the guides 502 on the cap 2 which cooperate with the reliefs 17 on the wall of the housing 16 of the frame 10.

The grinding tool can be made in such a way so to be housed, when the device is not used, inside the cavity of the diffuser 3, so to allow a more ergonomical setting of the accessories; likewise, as shown in FIG. 3, the foods steam cooking container 5 can be put down into the container too. In a not shown embodiment variation, the mincing device and the diffuser could be made in a single piece, providing for a cavity allowing the passing of the steam.

1. A multi-use device for domestic use, and in particularly for the children's feeding, including steam generating (20) and supplying (23, 24, 25) means, operating means (30, 31, 32, 33), a working container (1) where it can be set alternatively: food products mincing means (6, 206), containing means (5) for the steam cooking of food products, and supporting means (203) for the steam sterilization of items such as baby's bottles or the like, being houseable within said container steam diffusion means (102, 3), said steam diffusion means including a diffusion device (3) communicating with said steam supplying means (23, 24), able to support both the containing means (5) for the food products steam cooking, and the support means (203) of the items destined to the sterilization.

2. A device according to claim 1, characterized in that said diffusion device (3) includes an hollow tubular body, axially positioned in said container (1) substantially for a considerable length of its height, communicating at the end turned to the mouthpiece of said container (1) with said steam supplying means (24, 102) and provided with at least one opening at the opposite end.

3. A device according to claim 2, where said container is provided with a cap (2), said diffusion device (3) being inserted in a hole (202) passing through said cap, being obtained in said cap means (102, 212, 222) for the transfer of the steam from said supplying means (24) to said diffusion device (3).

4. Device according to claim 3, where said steam transferring means include a pour (102) which can be inserted at one end into the hole (25) of said supplying chamber (24), and at the other one communicating with an annular chamber (212) obtained concentrically to the through hole (202) of said cap, at its turn communicating with said diffusion device (3)

5. A device according to any claim 2 to 4, where said diffusion device (3) includes one or more supporting elements (203), extending radially as to said device (3), to it firmly connected.

6. A device according to claim 5, where said supporting means include one or more circular plates (203) axially bored, and provided with several housings (213) set radially and equidistant from each other.

7. A device according to claim 5 or 6, where the container (1) has one or more annular abutments on its inner side wall, suitable to support said overhanging supporting means (203).

8. A device according to any of the claims 2 to 7, where said means for the mincing of food products include a shaft (6) axially insertable into said container (1), provided at the end turned to the bottom of said container with one or more blades (206), and at the opposite end with means (106) for the coupling with said operating means (30), being said shaft made so to be housed, in rest mode, within said diffusion device (3).
